(19) United States
(12) Patent Application Publication
(10) Pub. No.: US 2009/0090400 A1
(43) Pub. Date: Apr. 9, 2009

(54) Water Delivery System For Multi-Position Spray Arm Of A Dishwasher

(75) Inventors: James Laurance Burrows, Winterville, NC (US); Douglas Jon Nagel, Waterloo, IA (US); Heinz T. Hermann, Charlotte, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 12/114,336

(22) Filed: May 2, 2008

Related U.S. Application Data
(60) Provisional application No. 60/916,124, filed on May 4, 2007.

(51) Int. Cl. A47L 15/22; B05B 3/04

(52) U.S. Cl. 134/178; 239/251

(57) ABSTRACT

A dishwasher with a height-adjustable upper rack carries a spray arm having a horizontal manifold tube that engages in a port of a check valve assembly coupled with a vertical main feed tube for supplying wash water to the spray arm. The check valve assembly defines a plurality of ports such that the manifold tube can engage a different one of the ports depending on the vertical position of the rack. The check valve assembly has flapper valves that pivot about horizontal axes and hang downwardly therefrom such that gravity tends to move the flapper valves toward their closed positions when the manifold tube is withdrawn from the ports.

### CROSS-REFERENCE TO RELATED APPLICATION

The present application claims the benefit of the filing date of U.S. Provisional Patent Application Ser. No. 60/916,124 filed on May 4, 2007, the entire disclosure of which is hereby incorporated herein by reference.

### BACKGROUND OF THE INVENTION

The present disclosure relates generally to automatic dishwashers, and more particularly to dishwashers that have a multi-position upper rack that slides in and out of the dishwasher to facilitate loading and unloading of the rack, and in which a spray arm is connected to the rack such that it moves inwardly and outwardly with the rack. The upper rack is adjustable between a plurality of positions differing in height.

The use of such height-adjustable upper racks has become more and more prevalent because of the versatility of being able to lower the upper rack when particularly tall items are to be placed in the rack, or to raise the upper rack when more vertical space is needed in the lower rack. The spray arm attached to the upper rack receives wash water from the pump of the dishwasher via a delivery system that includes a wash water feed tube typically extending vertically adjacent the rear wall of the tub, and a manifold tube that is attached to the upper rack. The feed tube in some dishwashers has a check valve assembly with multiple ports corresponding to the multiple positions of the upper rack. The manifold tube for the spray arm is placed in fluid communication with the feed tube by being inserted into one of the ports. The insertion of the manifold tube into the port opens a check valve to allow wash water to flow from the conduit into the manifold tube for the spray arm. Each port not being used is closed by a valve member of the check valve assembly. When the manifold tube is withdrawn from the active port upon sliding the upper rack out of the dishwasher, the associated valve member closes the port. The rack can then be slid back into the dishwasher in the same vertical position, or the rack can first be adjusted to a different vertical position and then slid back in such that the manifold tube is inserted into a different one of the ports.

A wide variety of valve and manifold tube arrangements have been developed or proposed for such dishwashers. The present disclosure relates to improvements in such valve and manifold tube arrangements.

### BRIEF SUMMARY OF THE DISCLOSURE

The present disclosure concerns a wash water delivery system for a height-adjustable, multi-position spray arm of a dishwasher. In accordance with one aspect of the present disclosure, a wash water delivery system for a height-adjustable spray arm in a dishwasher comprises (a) a main feed tube extending along a generally vertical direction for supplying wash water for the spray arm, the main feed tube having a front wall in which a plurality of separate apertures are defined, said apertures being spaced apart along the generally vertical direction; (b) a manifold tube for the spray arm, the manifold tube having an open end; and (c) a check valve assembly engaged with the main feed tube and defining a plurality of ports spaced apart along the generally vertical direction, each port being in fluid communication with a respective one of the apertures of the main feed tube, the check valve assembly including a plurality of valve members each respectively arranged to close one of the ports when the open end of the manifold tube is withdrawn from the port. A given one of the valve members is opened when the open end of the manifold tube is inserted into the respective port while the other port(s) is (are) held closed by the respective valve member(s).

The check valve assembly can further comprise (i) a front cover of relatively hard and rigid material releasably attached to the main feed tube, the front cover defining a plurality of separate generally cylindrical passages respectively aligned with the apertures in the main feed tube, each passage extending generally parallel to the generally horizontal direction and having a front end spaced relatively far from the main feed tube and a rear end spaced relatively closer to the main feed tube; (ii) a plurality of generally annular valve seats of relatively softer, less rigid material than the front cover and respectively attached to the front ends of the passages, the valve seats each defining a central hole of smaller diameter than an inner surface of the corresponding passage in the front cover; and (iii) a valve body of relatively softer, less rigid material than the front cover disposed between the main feed tube and the front cover. The valve body defines a plurality of separate orifices in respective sealing engagement with the passages of the front cover and with the apertures in the main feed tube, the valve body further comprising a flapper valve for each orifice. Each flapper valve is pivotally connected to the valve body so as to be pivotal between a closed position engaging the respective valve seat and an open position spaced from the valve seat. In the closed position, each flapper valve resides intermediate the front end and the rear end of the respective passage of the front cover. This arrangement gives the check valve assembly a relatively low profile such that it extends into the interior of the dishwasher a relatively small distance.

In one embodiment, each of the flapper valves is pivotal about an axis that is generally perpendicular to both the generally vertical and generally horizontal directions. Each flapper valve can be connected to an arm that extends generally parallel to the generally horizontal direction toward the respective valve seat for the flapper valve, and each flapper valve can hang downwardly from the respective arm. Accordingly, gravity tends to assist the “memory” of the flapper valve material in moving the flapper valves toward the closed position. This is advantageous relative to prior check valve assemblies in which the flapper valves pivot about vertical axes and therefore are not moved toward the closed position by gravity.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a perspective view, partly broken away, of a dishwasher in accordance with one embodiment of the invention;

FIG. 2 is a perspective sectioned view of a wash water delivery system and spray arm in accordance with one embodiment of the invention;

FIG. 3 is a cross-sectional view of the check valve assembly; and

FIG. 4 is an exploded view of the check valve assembly.

### DETAILED DESCRIPTION OF THE DRAWINGS

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

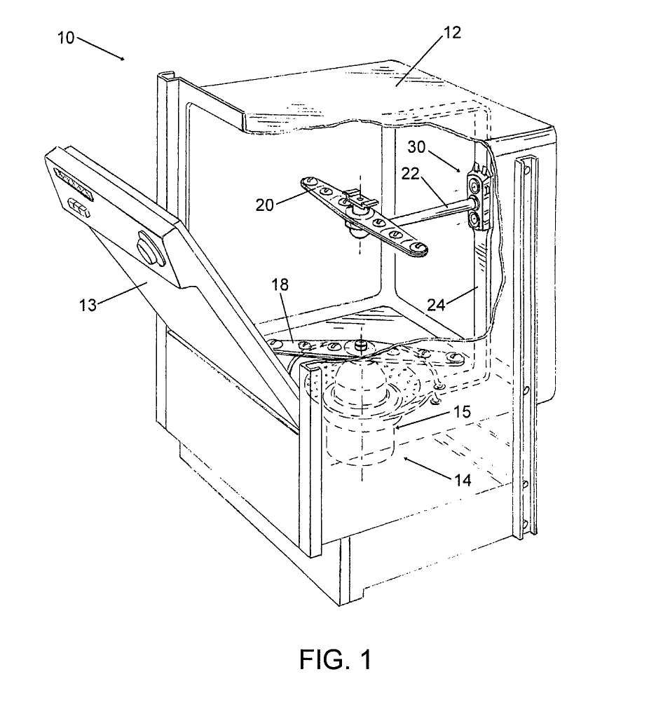

FIG. 1 shows a dishwasher 10 having a wash water delivery system in accordance with one embodiment of the invention. The dishwasher includes a tub 12 (partly broken away in FIG. 1 to show internal details) forming an enclosure in which dishes and utensils are placed for washing. The tub includes a door 13 that can be opened to access the interior of the tub. As well known in the art, the dishwasher includes a bottom rack and an upper rack (omitted from the drawings for clarity) for holding the dishes and utensils, and each of the racks is mounted to slide inwardly and outwardly through the open door to facilitate loading and unloading of dishes and utensils. The tub also defines a sump (shown generally at 14 in FIG. 1) in which wash water or rinse water is collected. The water is pumped by a pump 15 from the sump to various spray arms mounted in the interior of the tub for spraying the water under pressure onto the dishes and utensils. The spray arms are rotatable for ensuring that all areas in the interior of the tub are exposed to the water discharged from the spray arms.

The upper rack is adjustable to different vertical positions. This allows the user to lower the rack when inordinately tall items are to be placed in the upper rack, or to raise the rack when more vertical space is needed for items in the lower rack. In the illustrated embodiment, the upper rack has three different positions that can be selected. However, the invention is applicable to upper racks that have any number of vertical positions, including a single (non-adjustable rack) position.

The spray arms typically include an uppermost spray arm (not shown) mounted to an underside of an upper wall of the tub 12 for spraying water generally downwardly, and a lowermost spray arm 18 mounted on an upper side of a bottom wall of the tub for spraying water generally upwardly. The spray arms also include a mid-level spray arm 20 that is attached to an underside of the upper rack and is configured for spraying water both upwardly and downwardly. The spray arm 20 is supplied with water via a manifold tube 22 that extends generally horizontally along the underside of the upper rack. As will be appreciated, when the upper rack is adjusted to different vertical positions, the manifold tube 22 moves with the upper rack and thus also assumes different vertical positions.

The water delivery system for the spray arm 20 includes a main feed tube 24 that connects to the pump 15 at the lower end of the conduit, extends generally vertically upwardly adjacent a rear wall of the tub 12, and then turns to extend generally horizontally along the underside of the upper wall of the tub for supplying water to the uppermost spray arm. Along the generally vertical portion of the main feed tube is a check valve assembly 30 that cooperates with the manifold tube 22 to supply water to the mid-level spray arm 20. The check valve assembly 30 allows the manifold tube 22 to be fluidly coupled with the main feed tube 24 when the upper rack is slid all the way into the interior of the tub 12, and to be disconnected from the main feed tube when the upper rack is slid out for loading or unloading dishes and utensils.

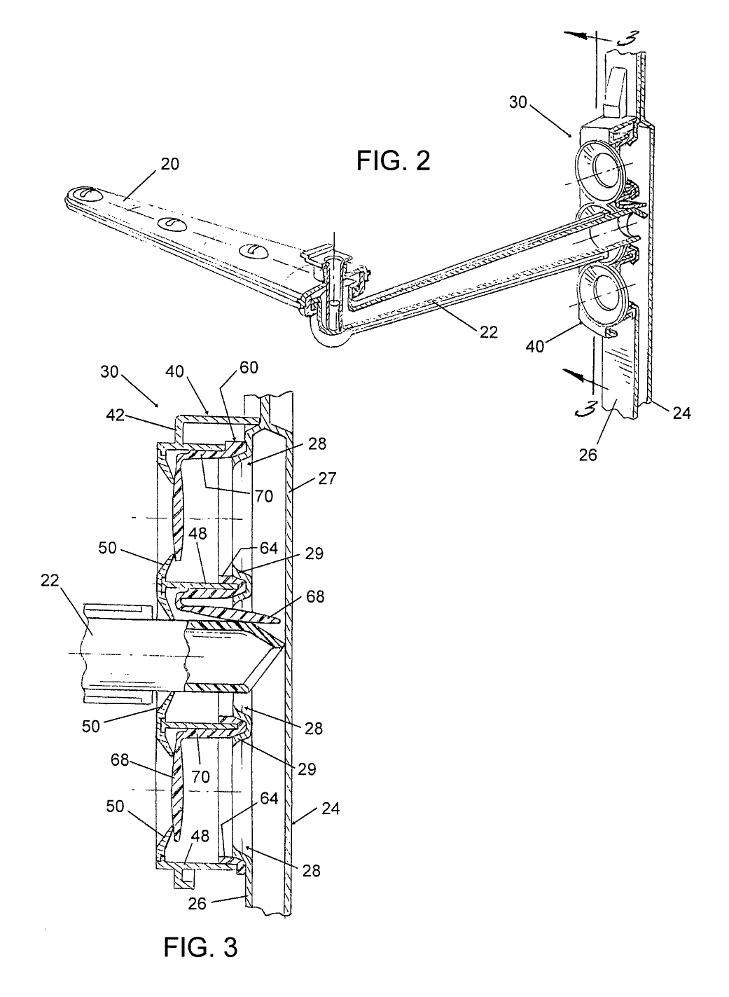

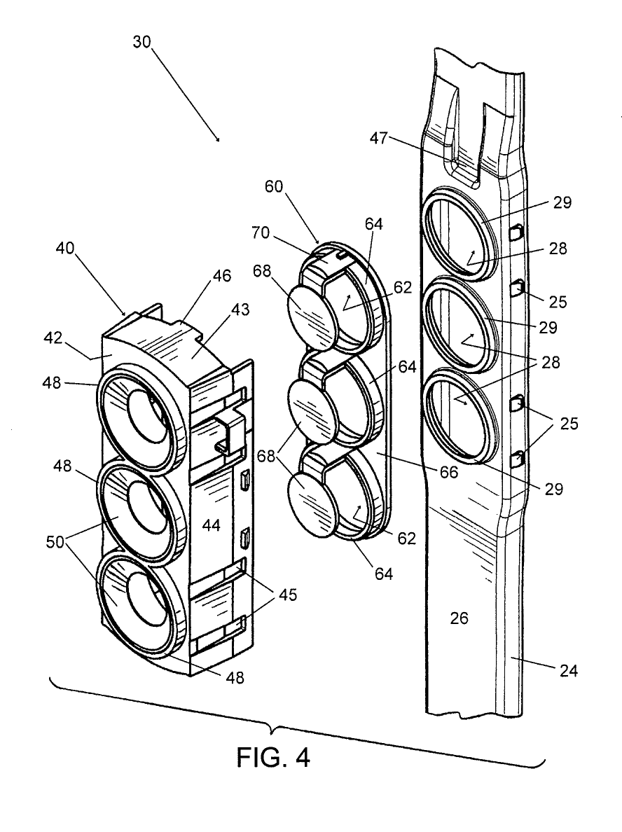

The wash water delivery system for the spray arm 20 is shown in detail in FIGS. 2 through 5. The system includes the manifold tube 22, the main feed tube 24, and the check valve assembly 30. The main feed tube 24 comprises a tubular structure having a cross-sectional shape that is generally rectangular, with the dimension in the front-to-back direction of the dishwasher being substantially smaller than the dimension in the side-to-side direction. The main feed tube thus is generally flattened so that it has a low profile on the rear wall of the tub. The main feed tube has a front wall 26 in which a plurality of apertures 28 are formed. The apertures 28 are spaced apart along the generally vertical direction in which the conduit extends. Each side edge of the main feed tube defines a plurality of vertically spaced protuberances or catches 25. A raised annular boss 29 surrounds each aperture 28 and projects in the forward direction (i.e., toward the door 13 (FIG. 1) of the dishwasher. Each boss 29 has a tapered or generally conical configuration such that the boss decreases in diameter in the forward direction.

The check valve assembly 30 comprises a front cover 40 and a valve body 60. The front cover 40 comprises a molded plastic structure that is relatively hard and rigid in comparison with the valve body 60. The front cover has a front wall 42, a top wall 43 joined to a top edge of the front wall and extending rearwardly therefrom, and a pair of spaced side walls 44 (FIG. 5, only one side wall 44 being visible) joined respectively to the opposite side edges of the front wall and extending rearwardly therefrom generally parallel to each other. Each side wall 44 defines recesses or apertures 45 that receive the catches 25 on the main feed tube in a snap-fit fashion, such that the front cover 40 can be secured to the main feed tube in snap-fit fashion. The top wall 43 of the front cover also defines a tab 46 that is received in a recess 47 defined in the front wall 26 of the main feed tube when the front cover is snapped into place on the conduit, for further stabilizing the connection between the front cover and main feed tube. The front cover 40 further defines a plurality of hollow generally cylindrical tubes 48 spaced apart along the generally vertical direction, the tubes thus forming generally cylindrical passages through the front cover. Each of the tubes 48 is aligned with a corresponding one of the apertures 28 in the main feed tube 24 when the front cover is snapped onto the conduit. Each tube 48 penetrates through the front wall 42 of the front cover and thus has a front end that extends slightly forward of the front wall. A rear end of each tube 48 is spaced slightly from the front wall 26 of the main feed tube 24 and the inner diameter of the tube is larger than that of the raised boss 29 surrounding the respective aperture 28 in the main feed tube.

The front cover 40 also includes a plurality of generally annular valve seats 50 of relatively softer, less rigid material than the front cover and respectively attached to the front ends of the tubes 48. The valve seats each defines a central hole of smaller diameter than the inner diameter of the corresponding tube 48. As illustrated, the valve seats advantageously have a tapered or generally conical configuration such that they decrease in diameter in the rearward direction toward the main feed tube 24. The valve seats 50 can comprise an elastomeric material such as silicone rubber or the like. The valve seats can be formed separately and then secured to the front cover, or alternatively the valve seats can be overmolded on the front cover. The overmolding process is well known and thus is not described further herein. The central hole in each valve seat 50 has a diameter slightly smaller than the outside diameter of the end portion of the manifold tube 22 such that a substantially sealed interface is formed between the manifold tube and the valve seat when the end of the manifold tube is inserted into the central hole of the valve seat.

The valve body 60 comprises a one-piece molded polymer structure that is of relatively softer, less rigid material than the front cover. The valve body is disposed between the main feed tube 24 and the front cover 40. The valve body defines a plurality of separate orifices 62 spaced apart along the generally vertical direction. Each orifice is defined by a short generally cylindrical protrusion 64 that extends in the forward direction from a generally planar portion 66 of the valve body. Each generally cylindrical protrusion 64 has an outer diameter that fits closely into the respective tube 48 of the front cover 40, and the rear ends of the tubes 48 abut the generally planar portion 66 of the valve body, such that a generally sealed interface exists between the tubes 48 and the protrusions 64 of the valve body. The generally planar portion 66 of the valve body is slightly compressed between the rear ends of the tubes 48 and the front wall 26 of the main feed tube 24, thereby providing a substantially sealed connection between the main feed tube 24, the valve body 60, and the front cover 40. Accordingly, wash water in the main feed tube is in fluid communication with the tubes 48 via the orifices 62 in the valve body 60.

The valve body 60 also includes a flapper valve 68 for each orifice 62. Each flapper valve is pivotally connected to the valve body so as to be pivotal between a closed position (shown for the uppermost and lowermost flapper valves in FIG. 3) engaging the respective valve seat 50 of the front cover, and an open position (shown for the middle flapper valve in FIG. 3) spaced from the valve seat 50. Each flapper valve in the closed position resides intermediate the front end and the rear end of the respective tube 48 of the front cover. In the illustrated embodiment, each flapper valve 68 is connected to the end of an arm 70 that is attached to the respective cylindrical protrusion 64 at its upper side. Each arm extends in the forward direction from the protrusion toward the respective valve seat 50 and then bends about 90° and extends a short distance downwardly and terminates at its connection to the flapper valve 68. The flapper valves 68 thus hang downwardly, and pivot about horizontal axes at their connections to the arms 70 when moved between the closed and open positions. Because the flapper valves hang downwardly from their pivot axes, gravity tends to assist the “memory” of the material in moving the flapper valves toward their closed positions.

To establish a connection between the spray arm manifold tube 22 and the main feed tube 24, the end portion of the manifold tube 22 is inserted into one of the ports defined by the check valve assembly 30, i.e., into the central hole defined by the valve seat 50. The end of the manifold tube thus pushes the flapper valve 68 to its open position, as shown for the middle port in FIG. 3. The other ports remain closed by the flapper valves 68, which are urged by water pressure against the valve seats 50 so that substantially no leakage of water occurs through the closed ports. The end of the manifold tube 22 abuts or is closely adjacent to the rear wall 27 of the main feed tube. Wash water thus can flow upwardly within the main feed tube 24 and enter the end of the manifold tube 22, where the water is then turned about 90° (i.e., from the generally vertical direction to the generally horizontal direction along which the manifold tube extends) to flow through the manifold tube 22 to the spray arm 20. The check valve assembly 30 thus allows a substantially sealed connection to be established between the manifold tube and the main feed tube in any of the plurality (three, in the illustrated embodiment) of vertical positions of the manifold tube corresponding to the various vertical positions of the upper rack to which the manifold tube is connected.

In operation, a user adjusts the upper rack of the dishwasher to the desired vertical position, which thus positions the manifold tube 22 in alignment with either the top port, the middle port, or the bottom port of the check valve assembly. Once the upper rack has been loaded with dishes and utensils to be cleaned, the upper rack is slid into the dishwasher, which causes the end of the manifold tube 22 to be inserted into the port corresponding to the rack position. The flapper valve 68 for that port is opened by the end of the manifold tube. The valve seat 50 substantially seals around the outside of the manifold tube. Additionally, the valve body 60 substantially seals the interface between the raised bosses 29 of the main feed tube and the tubes 48 of the front cover 40. Accordingly, water is substantially prevented from leaking from the main feed tube into the interior of the dishwasher tub, and instead at least part of the water is substantially constrained to flow into the manifold tube 22 to the mid-level spray arm 20. When there is a top spray arm, another portion of the water in the main feed tube flows around the manifold tube and is supplied to the top spray arm.

The wash water delivery system described and illustrated herein has a number of advantages or useful features relative to prior systems, including but not limited to the following:
the check valve assembly 30 has a relatively low profile, i.e., a relatively small thickness in the back-to-front direction, because the flapper valves 68 in their closed positions reside close to the front ends of the tubes 48 of the front cover and therefore in the open position the flapper valves extend a relatively short distance rearward of the rear ends of the tubes 48; this in turn allows the main feed tube 24 to have a low profile; and
the flapper valves 68 pivot about horizontal axes and hang downwardly from their pivot axes, and thus gravity tends to move the flapper valves toward their closed positions; this is advantageous in helping to ensure that the flapper valves are in close proximity to the valve seats 50 so that water pressure in the main feed tube 24 urges the flapper valves firmly against the valve seats of the ports not being used.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A wash water delivery system for a dishwasher spray arm that is adjustable between a plurality of different positions spaced apart along a first direction, comprising:
a main feed tube for supplying wash water for the spray arm, the main feed tube having a front wall in which a plurality of separate apertures are defined, said apertures being spaced apart along the first direction;
a front cover of relatively hard and rigid material releasably attached to the main feed tube, the front cover defining a plurality of separate generally cylindrical passages respectively aligned with the apertures in the main feed tube, each passage extending generally parallel to a second direction that is perpendicular to the first direction and having a front end spaced relatively far from the main feed tube and a rear end spaced relatively closer to the main feed tube;
a plurality of generally annular valve seats of relatively softer, less rigid material than the front cover and respectively attached to the front ends of the passages, the valve seats each defining a central hole of smaller diameter than an inner surface of the corresponding passage in the front cover; and
a valve body of relatively softer, less rigid material than the front cover disposed between the main feed tube and the front cover, the valve body defining a plurality of separate orifices in respective sealing engagement with the passages of the front cover and with the apertures in the main feed tube, the valve body further comprising a flapper valve for each orifice, each flapper valve being pivotally connected to the valve body so as to be pivotal between a closed position engaging the respective valve seat and an open position spaced from the valve seat, each flapper valve in the closed position residing intermediate the front end and the rear end of the respective passage of the front cover.

2. The wash water delivery system of claim 1, wherein each of the flapper valves is pivotal about an axis parallel to a third direction that is perpendicular to both the first and second directions.

3. The wash water delivery system of claim 1, wherein the valve body includes a plurality of generally cylindrical protrusions each defining one of the orifices, each protrusion fitting closely into the rear end of a respective one of the passages of the front cover.

4. The wash water delivery system of claim 3, wherein each flapper valve is connected to a respective one of the protrusions.

5. The wash water delivery system of claim 4, wherein each flapper valve is connected to a respective one of the protrusions by an arm that extends from the protrusion generally parallel to the second direction toward the respective valve seat for the flapper valve.

6. The wash water delivery system of claim 5, wherein the valve body comprises a one-piece molded part of elastomeric material.

7. The wash water delivery system of claim 5, wherein the first direction is vertical and each arm is located on an upper side of the respective protrusion, and each flapper valve hangs downwardly from the respective arm such that gravity tends to move the flapper valves toward the closed position.

8. A dishwasher, comprising:
a tub;
a height-adjustable spray arm including a spray arm manifold tube for delivering wash water to the spray arm, the spray arm manifold tube having an open end, the spray arm being adjustable between at least first and second positions differing in height; and
a wash water delivery system in accordance with claim 1, the main feed tube being disposed adjacent the rear wall of the tub for supplying wash water under pressure to the spray arm, the spray arm manifold tube being arranged such that moving the spray arm in the first position all the way inwardly causes the open end of the spray arm manifold tube to extend through the hole in a first one of the valve seats and push the respective flapper valve open to place the spray arm manifold tube in fluid communication with the main feed tube, and moving the spray arm in the second position all the way inwardly causes the open end of the spray arm manifold tube to extend through the hole in a second one of the valve seats and push the respective flapper valve open to place the spray arm manifold tube in fluid communication with the main feed tube.

9. The dishwasher of claim 8, wherein each of the flapper valves is pivotal about a horizontal axis that is perpendicular to both the first and second directions.

10. The dishwasher of claim 8, wherein the valve body includes a plurality of generally cylindrical protrusions each defining one of the orifices, each protrusion fitting closely into the rear end of a respective one of the passages of the front cover.

11. The dishwasher of claim 10, wherein each flapper valve is connected to a respective one of the protrusions.

12. The dishwasher of claim 11, wherein each flapper valve is connected to a respective one of the protrusions by an arm that extends from the protrusion generally parallel to the second direction toward the respective valve seat for the flapper valve.

13. The dishwasher of claim 12, wherein the valve body comprises a one-piece molded part of elastomeric material.

14. The dishwasher of claim 12, wherein each arm is located on an upper side of the respective protrusion, and each flapper valve hangs downwardly from the respective arm such that gravity tends to move the flapper valves toward the closed position.

15. A wash water delivery system for a height-adjustable spray arm in a dishwasher, comprising:
a main feed tube for supplying wash water for the spray arm, the main feed tube having a front wall in which a plurality of separate apertures are defined, said apertures being spaced apart along a generally vertical direction;
a manifold tube for the spray arm, the manifold tube having an open end; and
a check valve assembly engaged with the main feed tube and defining a plurality of ports spaced apart along the generally vertical direction, each port being in fluid communication with a respective one of the apertures of the main feed tube, the check valve assembly including a plurality of valve members each respectively arranged to close one of the ports when the open end of the manifold tube is withdrawn from the port, a given one of the valve members being opened when the open end of the manifold tube is inserted into the respective port while the other port(s) is (are) held closed by the respective valve member(s);
wherein each of the valve members pivots about a generally horizontal axis and hangs downwardly from said generally horizontal axis such that gravity assists in moving the valve members in a direction to close the ports when the manifold tube is withdrawn therefrom.
